(19) United States
(12) Patent Application Publication
(10) Pub. No.: US 2005/0096933 A1
(43) Pub. Date: May 5, 2005

(54) Offshore environment computer-based safety training system and methods

(75) Inventors: Rogers V. Collins III, The Woodlands, TX (US); Jonathan B. Fairbanks, Houston, TX (US); James R. Shiflett, (US)

Correspondence Address: BRACEWELL & PATTERSON, LLP;IP DOCKETING, P.O. BOX 61389, HOUSTON, TX, 77208-1389, US

(73) Assignee: Offshore Safety LP

(21) Appl. No.: 10/946,901

(22) Filed: Sep. 22, 2004

Related U.S. Application Data
(60) Provisional application No. 60/504,943, filed on Sep. 22, 2003.

(51) Int. Cl. G06F 17/60

(52) U.S. Cl. 705/1

(57) ABSTRACT

A computer-based training system and related methods utilizing a simulated offshore environment. The training system allows users to safely simulate various job tasks in which they are expected to perform prior to actually performing the job tasks in an offshore environment. Conditions can be altered each time to make the training session easier or more difficult, which also enables users to experience a different training scenario each time. The system allows users to make mistakes in a safe environment, before there are any real consequences, such as an injury or an environmental upset. The training system has reporting and updating capabilities to enable companies to determine the status of employee training and ensure that all of the procedures are current and consistent company-wide.

### RELATED APPLICATIONS

This application claims the benefit under 35 U.S.C. § 119(e) of U.S. Provisional Application Ser. No. 60/504,943, filed Sep. 22, 2003.

### BACKGROUND OF THE INVENTION

1. Technical Field of the Invention

The present invention relates generally to computer-based safety training programs. More specifically, the invention relates to software programs that provide training for employees of the offshore energy industrial environment.

2. Description of Prior Art

The offshore energy industry employs thousands of people that perform jobs that are dangerous to others or themselves if not performed properly. Mistakes made in many of these jobs could lead to injury, loss of life, or an environmental incident. Proper training is essential for an employee to perform his duties correctly and safely, particularly when the employee has a job that is dangerous. Training can be conducted in many different subjects related to a job. Training subjects can include operating procedures, safety procedures, safe work practices, industry standards, regulations, and the like. Many methods of training have been used throughout the years with varying levels of success.

Training historically consisted of a trainer teaching a trainee about a task and then possibly quizzing the trainee regarding the material that was learned. Much of the training was in a classroom setting without much “hands on” training. The trainer may not even be a live person in many instances. Training videos have become a popular alternative to live training sessions because the training could be conducted repeatedly and in various locations at various times. While this type of personal training may be appropriate for some jobs, this is not always the best type of training to use when making a mistake during the performance of a task could cause injury or an environmental excursion.

On-the-job training was another leading type of training for many jobs. The theory behind this type of training was that the trainee would be able to retain the material better since he was actually performing the task, as opposed to simply hearing about it in a classroom. This type of training results in many errors being made by the trainee and the trainer having to correct the mistakes of the trainee to ensure that the same mistake will not occur again. Some jobs though do not allow for any mistakes due to the dangerous nature of the job.

To address this problem, many types of simulators have been developed over the years, particularly for use in the aviation industry. While these types of training devices allow users to experience a simulated environment to one in which they will be working, simulators are typically expensive and cumbersome. If a company has numerous locations or remote sites such as an offshore platform, it is generally not economically feasible to provide enough simulators to adequately train its personnel. Changes to procedures are also difficult to distribute on a companywide basis and it is difficult to ensure that everyone has been trained on the most up-to-date materials.

A need exists for a more economical and efficient method of training employees in a manner that will capture the user's attention and help them retain what they have learned. It would be desirable for the training system to allow users to perform dangerous tasks repeatedly in a safe environment to ensure that they can perform the task properly prior to having to risk any real dangerous occurrence. It is an object and goal to provide a training system that captures the attention of the trainee, tracks their progress, and allows for a “hands on” experience without the danger of actually performing a task prematurely. It is an additional object and goal to provide a training system that will easily allow a company to determine the status of all training activities for its employees and ensure that all of the training materials are current and in compliance with applicable rules and regulations.

### SUMMARY OF THE INVENTION

In order to meet one or more of these goals, the present invention advantageously provides a system and method of training employees of the offshore energy industry using a computer software program that simulates an offshore industrial environment. The systems and methods of the present invention allow users to train in a virtual offshore environment while physically remaining in a safe environment.

The present invention advantageously provides a computer training system that simulates the offshore environment, such as an offshore platform, to train employees in operating procedures, safe work practices, and the like. The training system generally includes an offshore training software program, a personal computer with the offshore training software program preferably installed upon a memory of the personal computer, a remote server computer containing a training results database that contains training results based upon the completion of at least a portion of the computer training software, and a means for connecting, physically or otherwise, the server with the personal computer.

The training software allows users to simulate various job tasks in which they are expected to perform prior to actually performing the job tasks in an offshore environment. Conditions can be altered to make the training session easier or more difficult, such as having to perform job tasks at night or in a storm. The training software allows users to make mistakes in a safe environment, before there are any real consequences, such as an injury, an environmental upset, or worse.

The training system is very portable, since it can be operated on a personal computer virtually anywhere. The training system allows companies to quickly determine the training status of all personnel. The training system also allows companies to implement company-wide changes very quickly and ensure that such changes are being conveyed to its employees.

The present invention also advantageously provides a method of training employees in offshore-related job tasks by using a computer-based simulator that allows the employees to experience a virtual offshore industrial environment. The employees are allowed to customize their training experience by selecting various conditions for performing job tasks. As a result, each training session can be different, which enhances the learning process for the employees. The training software allows users to select crewmembers and their needed equipment to perform various job tasks that are typically performed by offshore environment workers. The training software also allows the users to control each crewmember while the crewmember performs each duty or step required to perform a job task. The job task is the overall job that needs to be performed and the duties are the smaller steps required to complete the job task.

### BRIEF DESCRIPTION OF THE DRAWINGS

So that the manner in which the above-recited features, advantages, and objectives of the invention, as well as others that will become apparent, are attained and can be understood in detail, more particular description of the invention briefly summarized above may be had by reference to the embodiments thereof that are illustrated in the drawings that form a part of this specification. It is to be noted, however, that the appended drawings illustrate only preferred embodiments of the invention and are, therefore, not to be considered limiting of the invention's scope, for the invention may admit to other equally effective embodiments.

FIG. 1 is a simplified block diagram of the training software system in accordance with an embodiment of the present invention;

FIG. 2 is a simplified block diagram of the databases and subroutines contained within the offshore training software program in accordance with an embodiment of the present invention;

FIG. 3 is a simplified flow diagram illustrating the methods of training using the offshore training software program in accordance with an embodiment of the present invention;

FIG. 4 is an image generated by the offshore training software program illustrating a history of a user's prior training sessions and allowing a user to alter the training experience by selecting a different task, a different skill level, and different weather conditions in accordance with an embodiment of the present invention;

FIG. 5 is an image generated by the offshore training software program illustrating relevant information, such as a task description and the weather conditions, for the training session in accordance with an embodiment of the present invention;

FIG. 6 is an image generated by the offshore training software program illustrating relevant information for each crew member in accordance with an embodiment of the present invention;

FIG. 7 is an image generated by the offshore training software program illustrating relevant information for each crew member in accordance with an embodiment of the present invention;

FIG. 8 is an image generated by the offshore training software program illustrating the individual duties that are required to perform a job task and whether or not the duties have been completed in accordance with an embodiment of the present invention; and

FIG. 9 is an image generated by the offshore training software program illustrating a third-person view taken from a selected crewmember's point of view in accordance with an embodiment of the present invention.

### DETAILED DESCRIPTION OF THE INVENTION

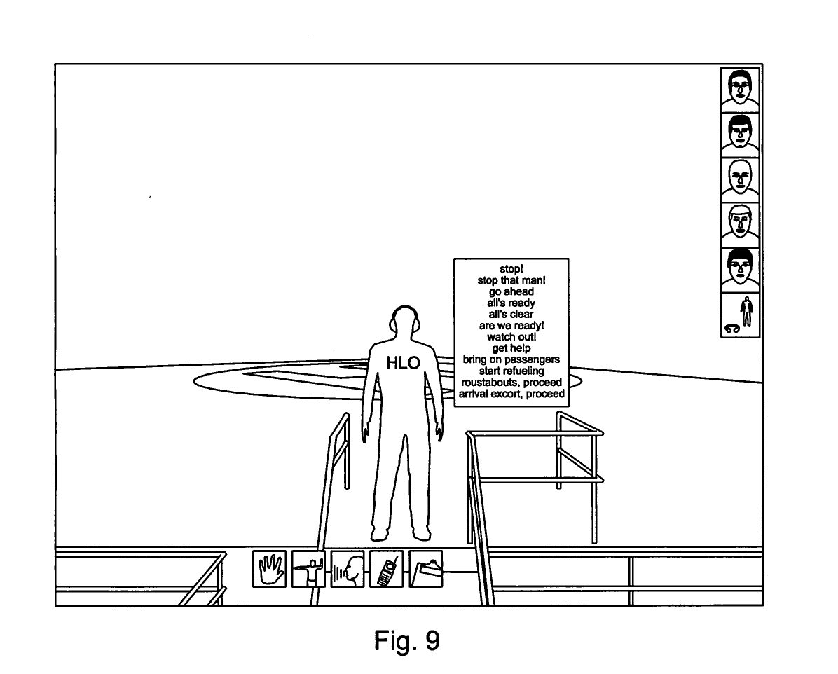

The current invention advantageously provides a computer based training system and a method of training users in a virtual, simulated offshore energy industrial environment. In one embodiment, the present invention advantageously provides a training system that includes an offshore training software program 30 that is operated on a personal computer 15 and connects to a central server 55 through a network 50. The offshore training software program 30 provides a virtual generic offshore industrial environment, as shown in FIG. 9, to provide users with the experience of virtually performing tasks in an offshore industrial environment without having to worry about any real world consequences until the user is adequately trained to actually perform the tasks on a real offshore platform. As an example, a helicopter loading officer could be trained using the training system to learn his job duties related to loading and unloading a helicopter without the consequences of actually making a mistake in the real world.

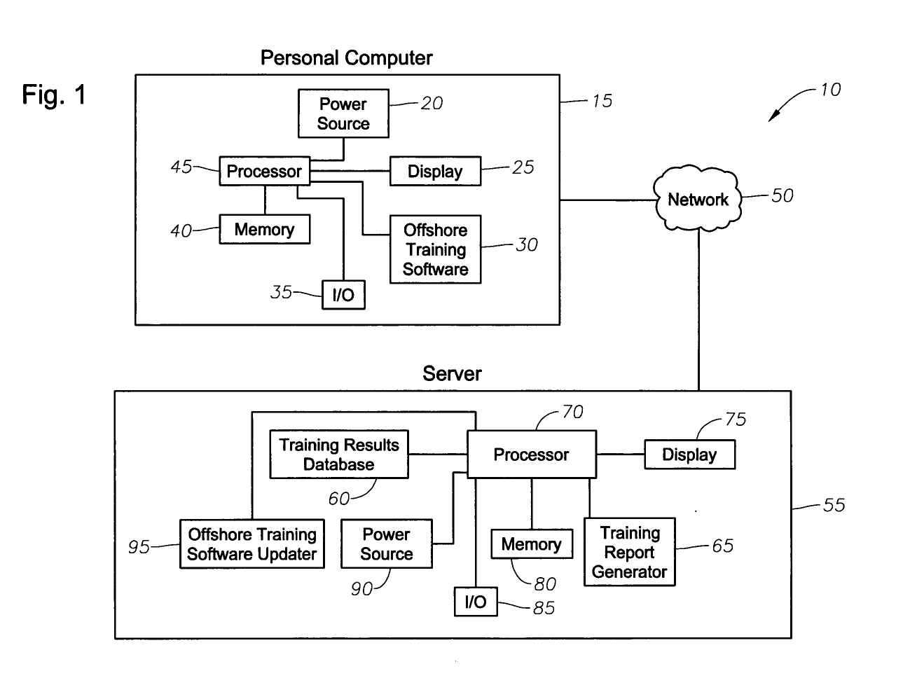

As shown in FIG. 1, personal computer 15 can also include other components in addition to the offshore training software program 30, such as a power source 20, a processor 45, a display 25, a memory 40, and an input/output means 35. Input/output means 35 can include computer keyboards, data ports, connectors, and other devices capable of transferring data to and from processor 45 as understood by those of ordinary skill in the art.

Network 50 preferably includes the Internet. Other types of networks such as intranets can also be used. Other suitable networks can be used and are to be considered within the scope of the present invention.

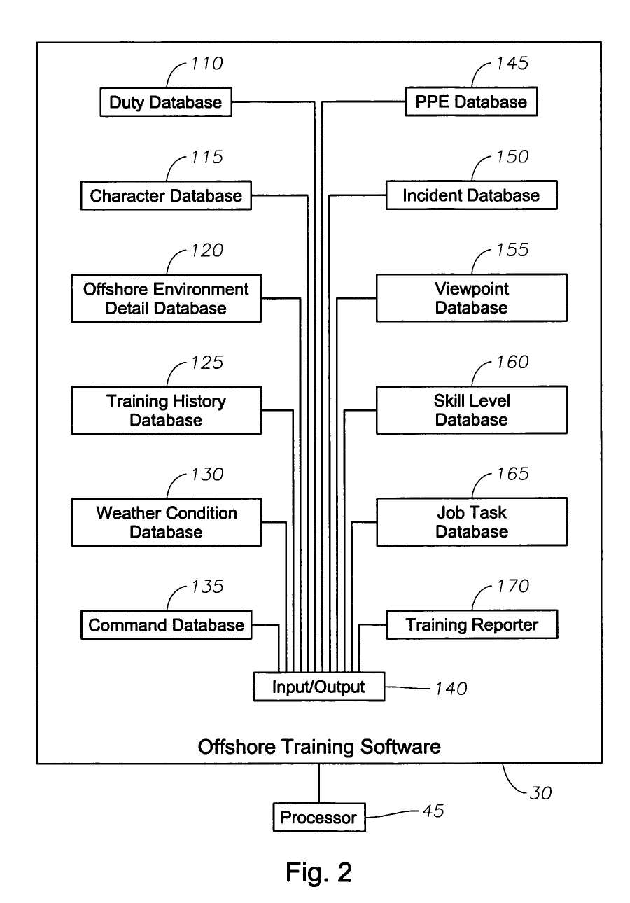

As illustrated in FIG. 2, the offshore training software program 30 includes databases and routines to create the virtual offshore industrial environment that is shown in graphical user interfaces on display 25. The software program can include a duty database 110, a character database 115, an offshore environment detail database 120, a training history database 125, a weather condition database 130, a command database 135, an input/output device 140, an equipment database 145, an incident database 150, a camera viewpoint database 155, a skill level database 160, a job task database 165, and a training reporter 170.

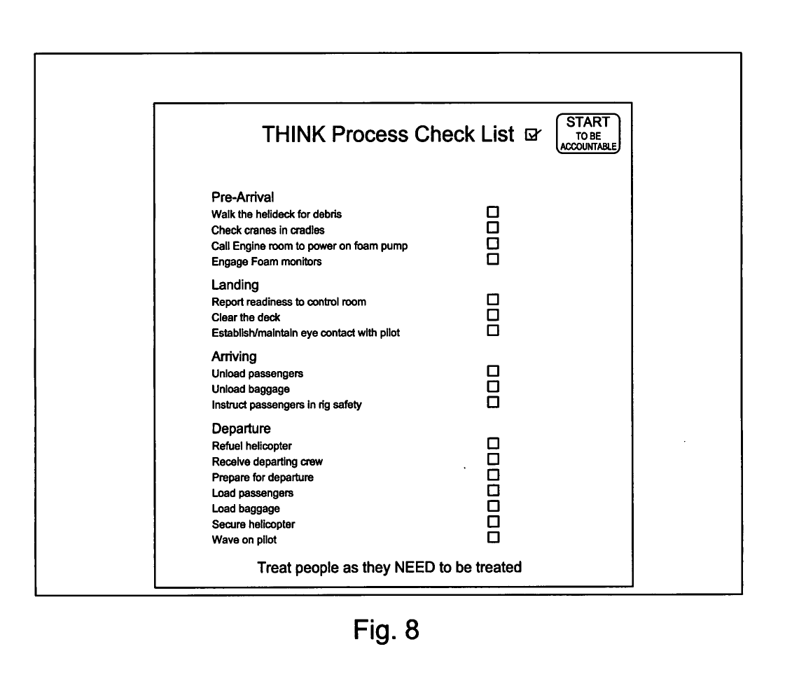

Duty database 110 advantageously includes information related to each job task that is selected by the user. To allow the user to better understand the individual steps or duties that are required to perform a particular duty, the training system generates a checklist of the necessary duties, as shown in FIG. 8 when the user is operating the training software. As the user progresses through the training session, the tasks will be checked off as they are completed. This feature enables users to determine what duties are still remaining and to ensure that they did not miss any duties.

Character database 115 advantageously provides information related to each one of the crewmembers selected by the user and any extraneous characters. Character database 115 can include information related to crewmembers, such as a helicopter landing officer (HLO), a fire officer, roustabouts, a helicopter pilot, helicopter passengers, and the like. Extraneous characters are similar to the offshore environment background in display 25 since they are not interactive.

Offshore environment detail database 120 advantageously includes the information necessary to create many of the major elements that are seen on the graphical user interface. Such elements can include a helicopter deck, an offshore platform, cranes, and an animated helicopter. Other elements can be included, such as boats and the like, and are to be considered within the scope of the present invention.

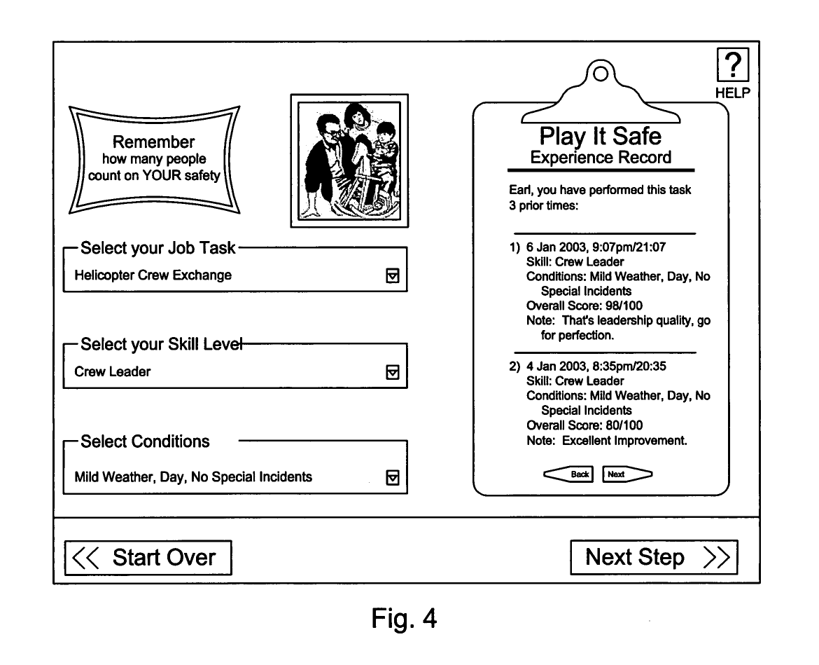

Training history database 125 advantageously provides a history for each user to review previous attempts at performing tasks using the offshore training software program 30. As shown in FIG. 4, information such as the date and time the training was performed, the skill level that was selected, the weather conditions selected, and the user's overall score can be provided. Additional details can be provided as part of this history and are to be considered within the scope of the present invention.

Weather condition database 130 includes information related to various weather conditions that could affect the job tasks selected. Weather conditions can include but are not limited to mild weather during the day, mild weather at anytime, typical weather at any time, and harsh weather at anytime.

Input/output device 140 can include connectors and other devices capable of transferring data to and from offshore training software program 30 to processor 45 as understood by those of ordinary skill in the art.

Equipment database 145 includes information related to the equipment that is assigned to each one of the crewmembers. Equipment can include personal protective equipment (PPE), forms, manuals, procedures, hand tools, power tools, and the like. The type of equipment that is needed for each job task varies depending upon the job task that has been selected. Additional types of equipment can be used and are to be considered within the scope of the present invention.

Incident database 150 can include information related to incidents, such as the criteria for determining whether an incident is minor or major. Incident database 150 can also include information related to the consequences of making a mistake within the offshore training software program 30. For example, if while refueling a helicopter in a training session, the user forgets to ground the fuel line, a fire would occur. Incident database 150 contains information related to incidents such as the resulting fire.

Camera viewpoint database 155 includes information related to the various camera angles that are available for use throughout the training session. Various viewpoints from the point of view of various crewmembers are shown on display 25 during the training sessions, as described herein.

Skill level database 160 can include information related to the skills that are required to perform various job tasks. Such information can include the proper personal protective equipment, certifications, the number and type of crewmembers required for a specific job task.

Job task database 165 includes information related to the job tasks described herein. Example job tasks can include inspecting a landing deck for a helicopter, monitoring the landing and departure of the helicopter, handing arriving and departing crewmembers, refueling the helicopter, and the like. Other job tasks related to the use of boats and other equipment needed in the offshore industrial environment can also be included and are to be considered within the scope of the present invention.

Training reporter 170 generates reports that are used within offshore training software program 30 to debrief the user, as described herein. Training reporter 170 preferably sends the results of the training session over network 50 to remote server 55. Training reporter 170 can be configured to send result reports automatically or upon demand.

As shown in FIG. 1, remote server 55 preferably includes a training results database 60, training report generator 65, a processor 70, a display 75, a memory 80, an input/output means 85, a power source 90, and an offshore training software program updater 95. Remote server 55 can also include additional components.

Training results database 60 preferably stores all of the training results performed by the users within a company. Training results database 60 can be any type of database suitable for adequately maintaining training records, such as Microsoft Access. Other database programs can be used and are to be considered within the scope of the present invention. Training results database 60 maintains personal statistics and performance logs for employees or users.

Training results generator 65 receives information from training reporter 170 and generates reports based upon the information sent by training reporter 170. Training results generator 65 allows companies to quickly provide training records of all of its employees easily. Reports can be generated using the database program to allow companies to quickly provide current training status when needed. This feature is particularly beneficial to companies during audits. Reports can be generated indicating the results of the training session and sent automatically or upon demand to the remote server. It is preferable for the report to be sent automatically to ensure that the company's training records are accurate. On-demand reporting can be used if the company wishes to allow users to practice the training sessions prior to the training session results being evaluated by the company. The reports that are sent to the server 55 from the personal computer 15 can be sent using the network 50 and its typical connection methods.

Offshore training software program updater 95 allows companies to upload changes in procedures, best work practices, regulations, and the like to all users of offshore training software program 30. Offshore training software program 30 is capable of being upgraded globally through remote server 55. This function allows a company to ensure that each user using the software program 30 on each computer has the most current version of the software program 30 and that all of the procedures related to the job tasks are current. This feature is particularly advantageous if a safe work practice changes based upon a new regulation or the like. If a safe work practice is changed, the change can be uploaded to each computer running the offshore training software program 30 to ensure that each site knows about the change in safe work practices. The company can then use the training reporter 170 and training report generator 65 to track the progress within the company towards complying with the new procedures or policies.

The company can customize the minimum criteria required for successful completion of each training session. For example, the company can specify that if a user receives a major incident report, it is necessary to complete the training again until there are not any major incidents. This feature allows companies to target areas that require extra focus for individuals and for teams. The company can also determine a numeric score that is considered the minimum acceptable score for its employees. This type of information can be globally distributed throughout the company using offshore training software program updater 95.

The offshore training software program 30 preferably is accessed on a compact disc (CD) or digital versatile disc (DVD) and runs locally on the personal computer 15. Other formats, such as downloading or accessing the offshore training software program 30 through the Internet, can also be used and are to be considered within the scope of the present invention.

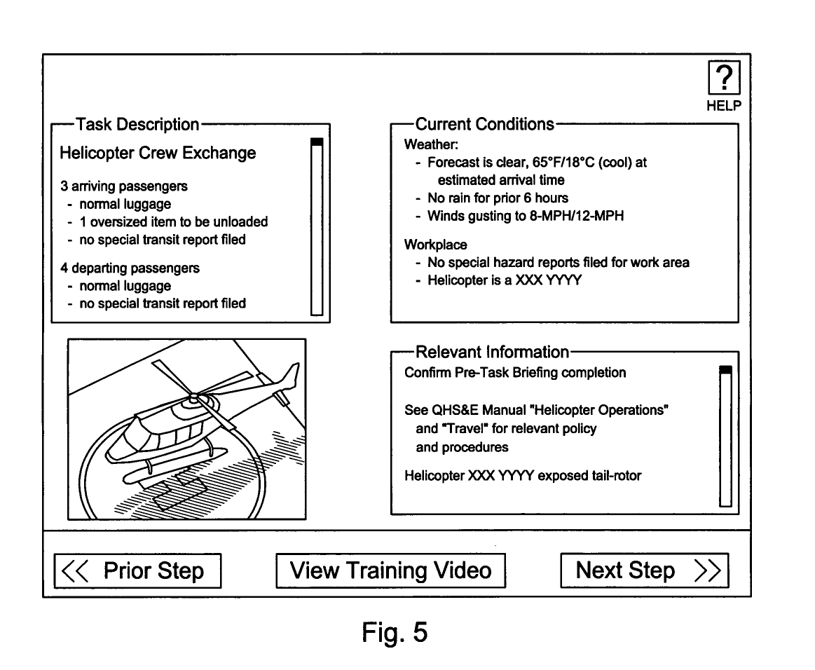

The offshore training software program 30 is very versatile. The offshore training software program 30 allows users to experience a different training session each time they run the program. As shown in FIG. 4, a user can alter his training experience by changing variables, such as the job task in which he is being trained, his skill level, and weather conditions. The offshore training software program 30 will operate in response to the input of these variables. For instance, if the user selected bad weather conditions, the training session will be much more difficult than if the user had selected a mild, sunny day. Additional variables could be added to increase the flexibility of allowing users to customize his training experience and would be considered within the scope of the present invention. To confirm the choices selected by the user, the offshore training software program 30 advantageously provides a summary of the variables selected, as shown in FIG. 5, along with any other relevant information that would allow the user to complete the task easier, such as any relevant safety procedures or the like.

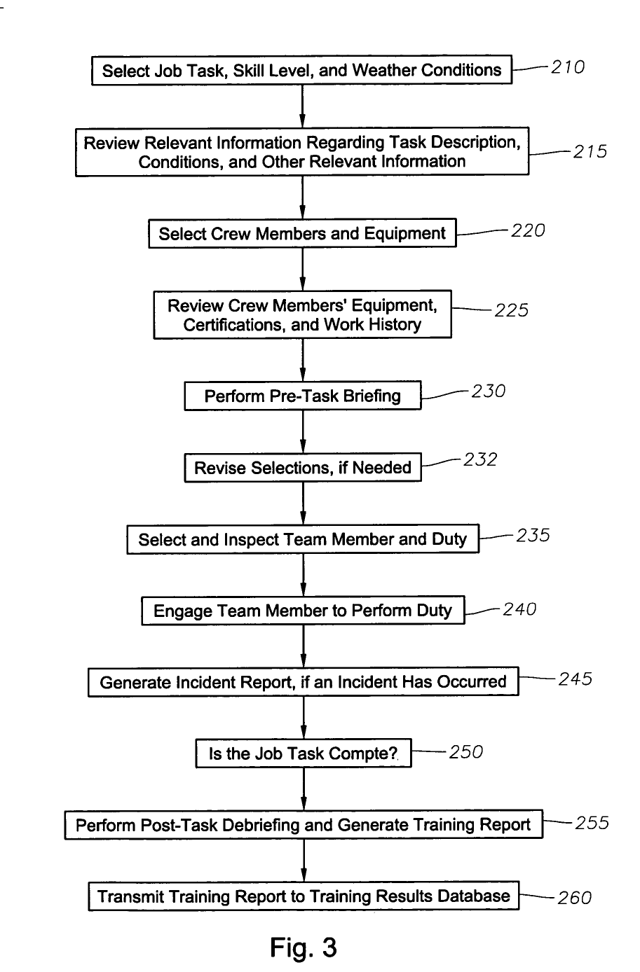

In addition to the training system provided, methods of training users by utilizing the training software system are also advantageously provided. As described in FIG. 3, to begin the training session, a job task, a user's skill level, and the weather conditions are selected by the user (block 210). The selections made in the method embodiments of the present invention are received by a personal computer that contains the computer based training software. The user can then review the relevant information regarding the task description, conditions, and other relevant information related to the job task (block 215). The user can then select crewmembers and the equipment that each crewmember will need to complete the job task (block 220). The user can then review and inspect the selected choices related to the crewmembers, equipment, and qualifications (block 225).

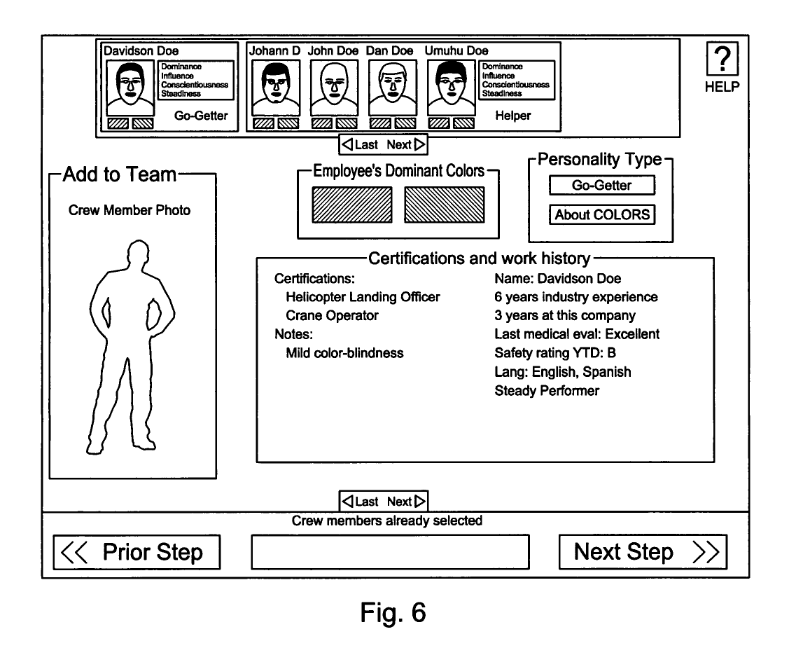

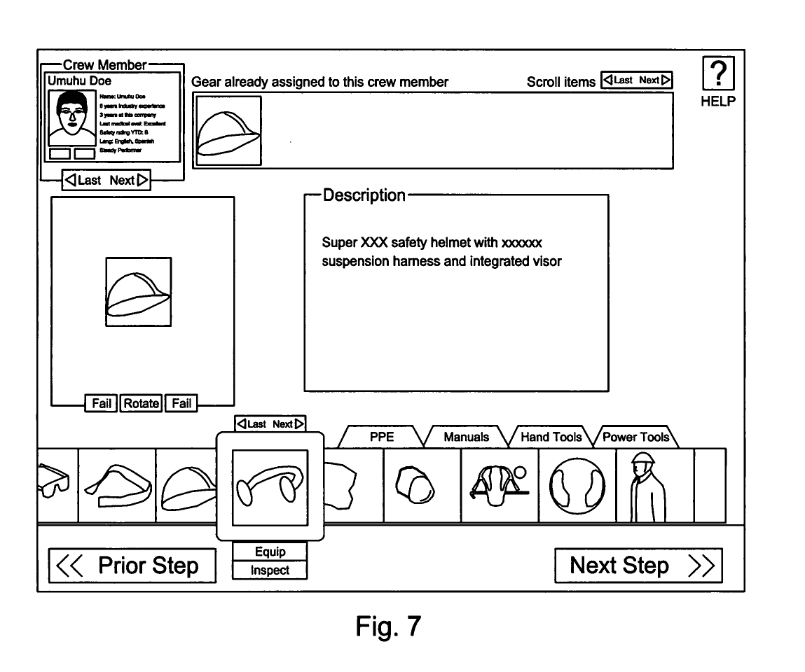

Offshore training software program 30 allows the user to select a crew based upon the job task selected and assign duties related to the job task to individual crewmembers. This feature helps develop leadership skills in the user and is useful in analyzing the strength of the user's leadership skills. Some duties require specialized certifications or experience, while others can be handled by any available crewmember. The score of the user is affected if the user attempts to assign duties to crewmembers without proper certifications. Each member has different qualifications and work experience to simulate real-work situations. As shown in FIGS. 6 and 7, the certifications, work history, ratings, the employee's dominant colors, personality type, and assigned gear and equipment of each crewmember can be accessed by clicking on the picture of the appropriate crewmember. Dominant colors are based upon a personality temperament test that determines relative tendencies about employees and characterizes them into four color categories, blue, green, red, and yellow. Many companies include the two dominant colors of its employees on the employee's business cards, helmets, and other personal items. The personality type information is generally based upon the two dominant colors of the employee. Additional information can be added about each crewmember as desired.

Offshore training software program 30 also allows the user to issue all of the equipment that is needed for the job task to the crewmembers. The user is also responsible for properly inspecting every issued item to assure fitness and safety for the expected use of such equipment. The user can provide any number of equipment to the crewmembers, but the overall scoring of the training session will be affected if the user deviates from the company's best practices. A crewmember can be given more than one piece of the same equipment. The software program allows the user to inspect the equipment and determine if the equipment passes or fails the inspection. The equipment can be rotated to ensure that the user inspects the equipment thoroughly.

Once the crew and equipment have been selected, the user performs a pre-task briefing routine (block 230). The pre-task briefing routine can include performing several tasks. One such task is inspecting each crewmember to ensure that they are wearing their equipment properly and to ensure compliance with work dress codes. Another task is developing a task plan that can include such information as the job task; a plan for completing the task; a determination of areas, equipment, and materials that need to be inspected and by whom; identification of hazards and any needed control measures needed to reduce the hazards; a communication to those involved or affected by the job task and a determination of who is responsible for the communication; and a determination if it is safe to proceed, what will be done to ensure that it remains safe; and identification of additional hazards that were identified during the task and how they were controlled. The task plan can be customized as needed based upon the job task. As another task that is performed during the pre-task briefing, the user can determine if it safe to proceed with the job task, and if each crewmember is properly certified, equipped, and inspected.

Offshore training software program 30 allows the user to make bad or poor job assignments and other mistakes prior to performing the pre-task briefing step (block 230). The previously selected choices made by the user can be revised, if necessary (block 232). Revisions are required if the user has made any mistakes, such as selecting an improper crewmember to perform a selected duty or improperly equipping a crewmember with improper equipment. Offshore training software program 30 will remember the previous selections in order to prevent the user from having to re-enter the same date, which wastes time. The user will go through any intervening screens between the screen upon which the mistake was made and the last screen in which the user was on. This feature re-emphasizes the training material to ensure that the user will not make the same mistakes again. Repetition is proven to be an effective learning tool.

Once the pre-task briefing tasks are complete, then the user selects and inspects a crewmember to perform the first duty required to perform a job task (block 235). The selected crewmember then is controlled by the user to perform the duty (block 240). Once the crew has been chosen, the user can become any member within the crew to help perform a duty that is needed to complete the particular job task. The user can control the crewmembers to make them perform various duties that are required to complete a job task. For example, if the job task was to unload a helicopter with passengers, the checklist shown in FIG. 8 can be used to show the duties required to complete the job task.

The user can control the movement of each member by using typical gaming techniques, such as using a mouse, a joystick, mouse buttons, the arrow keys on a keyboard, or the like. The offshore training software program 30 allows users to put themselves in the shoes of each crewmember by selecting a particular crewmember. Different camera views related to that particular crewmember can be selected. FIGS. 6 and 9 illustrate two of the different camera views that are available for a crewmember. FIG. 9 illustrates a third-person, or over the shoulder, view from the selected crewmember's point of view. FIG. 6 includes an illustration of a first person, or bird's eye, view from the selected crewmember's point of view. Other available camera views can include free flying, perspective views from a selected crewmember's point of view taken at various angles and zoom ranges. The camera view can be controlled by using normal focus control commands, as understood by those of ordinary skill in the art.

Once the selected crewmember has completed the duty, another crewmember can be selected and engaged to perform the next duty required to perform the job task (block 250). In order to ensure that each job task is completed accurately, the user will have to assume control of each crewmember at the proper time. The user will have to know the sequence of the duties and the qualifications and equipment required for each duty.

If the user makes a mistake that would have resulted in an incident if the user had made the same mistake in the real world, an incident report is generated (block 245). The severity of the consequences related to the mistake will determine what type of incident report is generated. If a major incident, such as a serious injury or a serious environmental excursion, occurs, then a major incident report will be generated. Major incidents can be used to require the user to start the training session over.

Offshore training software program 30 can include various levels of training reports, based upon the severity of the incident. For example, if the user did not perform the duties in the proper order that are required to refuel a helicopter, such as grounding the fuel line, the helicopter will catch on fire and a major incident report will be generated.

If the user makes a mistake, then they can go back and correct the mistake if they catch it prior to an incident occurring. Training reporter 170 will report the mistake, but also indicate that the user corrected the mistake on their own.

Offshore training software program 30 includes some characters that cannot be controlled by the user. These extraneous characters function similarly to the background of the offshore environment, like the platform or equipment. The extraneous characters can respond to commands from the crewmembers controlled by the user, but offshore training software program 30 controls these characters. The extraneous characters essentially function as part of the offshore environment.

Once the job task is complete, the user experiences a post-task debriefing (block 255). In the post-task debriefing step, the user is then reviewed, or scored, for his choices made throughout the training session. The reviewing includes the overall job task performance including the equipment selected by the user, the inspection performed, the personnel selected, and any of the other decisions made by the user. The user is then provided with constructive criticism, recommendations for improvement, and a final score. Scoring can be accomplished by using an observation system known as “START”, which stands for See, Think, Act, Report, Track. In this system, details such as behavior, body positions, personal protective equipment, tools and equipment, safe work conditions, environmental conditions, and the like can be evaluated. Only the relevant details are scored, based upon the job task. Additional factors can be considered when scoring the training results, such as if corrective action was required, if the task planning drill was fully and properly used, if there was an accident or a near miss, if relevant work permits were obtained and confirmed, if the procedures were adequate, if the procedures were followed, and the like.

The results of each training session can be sent automatically to the server so that the company can access up-to-date training records at any time (block 260). The company can generate training reports using training report generator 65 for each user to indicate whether or not required training has been performed and the results of such training. This feature will enable companies to easily provide training records when needed, such as for regulatory compliance audits and in the event of an incident.

Many advantages exist resulting from the use of the software training program and the associated methods. As an advantage of the invention, the training that is provided through the use of the training software system holds the attention of the user to enhance the learning process of the user. The training system and methods are interactive, as opposed to passive learning as with prior training methods, which enhances the user's retention of the material. Since the training system resembles the feel of a game, the training is fun for the users, which helps keep the user's attention throughout the training session. Users achieve a higher level of safety awareness as a result of using the training program.

Other advantages exist, such as the training system can be customized for various tasks or for company specific needs and the software monitors and corrects behavior within the software program and connects the user's actions with consequences. The system and methods provide information to the company that enables supervisors to access an employee's understanding of the safety issues related to their prior to resulting in an accident.

Another advantage is that the program provides the company with feedback regarding areas in which the user needs more training or has successfully completed. As yet another advantage, the training system allows a company to adopt company-wide modifications to procedures and practices, implement these changes quickly, and ensure that all employees are trained with the most current information.

Unlike prior training methods, the present invention is focused on keeping the user's attention and providing supervisors with measurable performance tracking. The offshore training software program 30 brings the trainee into a familiar 3D world where they will perform their day-to-day tasks with an emphasis on following corporate safety procedures. By monitoring and correcting behavior within the simulation, the trainee can readily make the association of their actions/in-actions with their associated consequences; in graphic detail, where necessary. This new level of safety awareness can, quite easily, transfer into their performance on their real job.

The present invention provides intelligent interactive multimedia training in a cost effective package. As another advantage of the present invention, personal statistics and performance logs of all employees are provided for use by the company. Areas requiring focus, along with progress being made, can be presented summarily and individually, which can provide an HSE department with valuable data on an employee's understanding of safety issues before they result in lost time, or serious accident.

The operating instructions or software program described in the present invention are not inherently related to or required by a particular computer or other server hardware. Various conventional computers or servers can be used according to the present invention. In addition, the present invention is not described with reference to any particular programming language. It will be understood that a variety of programming languages may be used to implement the system and method of the present invention as described herein.

While the invention has been shown or described in only some of its forms, it should be apparent to those skilled in the art that it is not so limited, but is susceptible to various changes without departing from the scope of the invention.

For example, various other job tasks can be added and the environment can be changed, such as from the viewpoint of a boat within the ocean. As another example, additional weather conditions can be added, such as hurricane conditions.

1. An offshore computer software training system that utilizes a virtual offshore industrial environment, the system comprising:
a personal computer for use by a user comprising a processor and memory coupled to the processor to store an offshore training software program that provides the user with the virtual offshore industrial environment in which the user can experience a simulated offshore rig environment during training; and
a training reporter that generates reports that are used within the offshore training software program and sends the training software program to an administrator site remote from the personal computer.

2. The system of claim 1, further comprising:
a remote server computer positioned at the administrator site remote from the personal computer, the remote server having a processor and memory coupled to the processor to receive and store training session results from the offshore training software program and for sending updates to the offshore training software program to the personal computer for upload; and
a network connection for allowing the personal computer and the remote server computer to upload updates to the offshore training software program and download training session results from the offshore training software program.

3. The system of claim 2, wherein the remote server computer further includes a training report generator connected to the processor for receiving information from the training reporter and generating reports based upon the information from the training reporter.

4. A computer memory element stored in a computer memory containing a database comprising data in computer readable format, the data including:
data indicating a job task;
data indicating a character;
data indicating an offshore environment detail;
data indicating a training history of a user;
data indicating weather conditions;
data indicating an equipment;
data indicating an incident;
data indicating a camera viewpoint;
data indicating a skill level; and
data indicating a job task.

5. The computer memory element of claim 4, wherein data indicating a character includes data related to a crewmember selected from the group consisting of a helicopter landing office, a fire officer, a roustabout, a helicopter pilot, a helicopter passenger, and combinations thereof.

6. The computer memory element of claim 4, wherein data indicating an offshore environment detail includes data related to a major element selected from the group consisting of a helicopter deck, an offshore platform, a crane, an animated helicopter, and combinations thereof.

7. The computer memory element of claim 4, wherein data indicating a training history of a user includes data related to training information selected from the group consisting of a date the training was performed, the time the training was performed, a skill level selected by the user, weather conditions selected by the user, the user's overall score, and combinations thereof.

8. The computer memory element of claim 4, wherein data indicating weather conditions includes data related to a weather condition selected from the group consisting of mild weather at day, mild weather at night, typical local weather at day, typical local weather at night, harsh weather at day, harsh weather at night, and combinations thereof.

9. The computer memory element of claim 4, wherein data indicating an equipment includes data related to equipment selected from the group consisting of personal protective equipment, a form, a manual, a procedure, a hand tool, a power tool, and combinations thereof.

10. The computer memory element of claim 4, wherein data indicating an incident data includes data related to incident information selected from the group consisting of criteria for determining whether an incident is a minor incident or a major incident, consequences of making a mistake while performing a job task, consequences of incidents, and combinations thereof.

11. The computer memory element of claim 4, wherein data indicating a skill level includes data related to required equipment and skills for a specific job task, the equipment and skills being selected from the group consisting of proper personal protective equipment, certifications, number of crewmembers, a type of crewmember, and combinations thereof.

12. The computer memory element of claim 4, wherein the data indicating a camera viewpoint includes data related to a camera view selected from the group consisting of a third person view from a selected crewmember's point of view, a first person view from the selected crewmember's point of view, a perspective view from the selected crewmember's point of view taken at an angle, a perspective view from the selected crewmember's point of view taken at a zoom range, and combinations thereof.

13. A computer-implemented method of performing a training session for users utilizing a simulated off-shore environment, the method comprising the steps of:
selecting a job task, a skill level, and weather conditions;
selecting crewmembers and equipment that each crewmember will need to complete the job task;
assigning duties and the equipment to crewmembers based upon the job task selected;
inspecting the equipment for deficiencies;
performing a pre-task briefing;
selecting a crewmember and performing an assigned duty that is assigned to the selected crewmember required to perform the job task until each crewmember is selected and each assigned duty required to perform the job task is complete; and
performing a post-task debriefing; and
generating a training report to report results of the training session.

14. The method of claim 13, further including the step of reviewing relevant information selected from the group consisting of a task description, conditions, and combinations thereof prior to the step of selecting crewmembers and equipment.

15. The method of claim 13, further including the step of revising assignments of the job tasks and the equipment made to the crewmembers if the assignments were improper.

16. The method of claim 13, further including the step of generating an incident report if a mistake is made during the step of selecting a crewmember and performing an assigned duty that would have resulted in an incident in a real world.

17. The method of claim 16, wherein the incident report is selected from the group consisting of a major incident report and a minor incident report, depending upon consequences of the mistake.

18. The method of claim 13, wherein the step of performing a pre-task briefing comprises:
inspecting each crewmember to ensure that the crewmember is wearing the equipment properly and to ensure compliance with work dress codes; and
developing a task plan that contains task information selected from the group consisting of the job task, a plan for completing the job task, a determination of areas that need to be inspected, a determination of equipment that need to be inspected, a determination of materials that need to be inspected, a hazards identification, identification of any needed control measures to reduce hazards, identification of any needed communication between crewmembers related to the job task, a determination of the crewmembers needing communication related to the job task, a determination of the communicator of the communication between crewmembers related to the job task, a determination if it is safe to proceed with the job task, identification of tasks to be performed to ensure that performance of the job task remains safe, identification of additional hazards identified during the job task, verification that each crewmember is properly certified for the job task, verification that each crewmember is properly equipped for the job task, verification that each crewmember is properly inspected, and combinations thereof.

19. The method of claim 13, wherein the step of performing a post-task debriefing comprises:
reviewing choices made throughout the training session selected from the group consisting of the equipment selected by the user, the inspections performed, the crewmembers selected, and combinations thereof; and
providing recommendations for improvement to the user; and
providing a final score for the training session.

20. The method of claim 13, wherein the step of generating a training report to report results of the training session includes sending the training report to the remote server to enable training records to remain current.

21. The method of claim 13, further includes the step of updating the duties required to perform the job task if there are changes to procedures related to the job task.
